(19) United States
(12) Patent Application Publication
(10) Pub. No.: US 2009/0070256 A1
(43) Pub. Date: Mar. 12, 2009

(54) SYSTEMS AND METHODS FOR PAYMENT

(75) Inventor: Frans Lundberg, Umea (SE)

Correspondence Address: SCHWEGMAN, LUNDBERG & WOESSNER, P.A., P.O. BOX 2938, MINNEAPOLIS, MN, 55402, US

(73) Assignee: Skycash Sp. z o.o., Warsaw (PL)

(21) Appl. No.: 12/203,656

(22) Filed: Sep. 3, 2008

Related U.S. Application Data
(60) Provisional application No. 60/969,835, filed on Sep. 4, 2007.

(30) Foreign Application Priority Data
Oct. 22, 2007 (SE) 07023427

(51) Int. Cl. G06Q 40/00

(52) U.S. Cl. 705/39; 705/35

(57) ABSTRACT

Embodiments include systems and methods including a computer network for making electronic payments between monetary accounts issued by different issuers, comprising a plurality of user issuers, each of the user issuers operable to provide one or more user accounts, a plurality of issued user accounts, each one of the plurality of issued user accounts issued by one of the user issuers, and each one of the plurality of issued user accounts communicatively coupled though a communication channel to the user issuer that issued the given issued user account, and at least one settlement issuer, the settlement issuer communicatively coupled to one or more of the plurality of user issuers.

### RELATED APPLICATIONS

This application claims priority under 35 U.S.C. 119(e) to U.S. provisional application No. 60/969,835 filed Sep. 4, 2007, and claims priority under 35 U.S.C. 119(a) to Swedish Patent Application number 0702342-7 filed Oct. 22, 2007, both of which are incorporated herein by reference.

### BACKGROUND OF THE INVENTION

Payment systems can include systems, such as retail payment systems, that are used to settle financial transactions. The financial transactions can be one or more financial transactions between parties, for example between two persons, between a person and a merchant, or between two or more financial institutions.

### BRIEF DESCRIPTION OF THE DRAWINGS

The embodiments of the present inventive subject matter are illustrated by way of example and not limitation in the figures of the accompanying drawings, in which like reference numbers indicate similar elements, and in which:

FIG. 1 illustrates a block diagram of a computer network including a multi-issuer account system;

FIG. 2 shows an example of a hierarchy of issuers and a single-currency inter-issuer payment.

FIG. 3 shows an illustrative an example of a hierarchy of issuers and a multi-currency inter-issuer payment;

FIG. 4 shows a flowchart for various methods for performing a payment; and

FIG. 5 shows a flowchart for various method for generating a payment specification.

### DETAILED DESCRIPTION

The scope of the invention is limited only by the claims, not by the description in this section.

The next several paragraphs discuss terminology used within the specification. The terms defined below are useful for describing the embodiments of the present invention and the prior art. Some of the terms are generally used and some are defined for this document.
A real-time payment is a payment for which the money paid can be reused for new payments by the receiver within one minute after the payment was initiated by the payer.
A delayed payment is a payment for which the receiver of the payment does not get immediate access to the transferred funds and no immediate notification that the funds will be received. International inter-bank payments are often delayed payments.
A half-delayed payment is a payment for which the receiver does not get immediate access to the funds, but is notified of the payment within one minute. The paid amount is available to the receiver at a later time. The payments in the Visa™ and MasterCard™ payment systems are half-delayed, since the receiver does not get immediate access to the received funds, but get an immediate notification of the payment.
A symmetric payment system is a payment system in which any user can pay to any other user of the system. There are no users that can only pay or only receive money.
An asymmetric payment system is payment system that is not symmetric. Examples of asymmetric payment systems include credit card systems and premium SMS payment systems that have special accounts for payment receivers (merchants).
In this document an account or monetary account is a balance of a single currency stored digitally by an account issuer. The balance of the account represents a liquid asset that can be used for payments if a balance in each of the payment accounts included in the payment path is equal to or greater than the payment amount.
In this document a currency is a unit of exchange facilitating the transfer of goods and services. Currency include, but is not limited to, money issued by central banks, such as EUR and USD.
In this document, an account system is a set of accounts handled by an account issuer. A transfer or balance transfer is a decrease of the balance of one account and a corresponding increase of the balance of another account in the same account system.
A multi-issuer payment system is a payment system consisting of many issuers that each handles an account system. An issuer can issue new accounts and remove accounts previously created by the issuer. Visa™ and MasterCard™ are examples of multi-issuer payment systems.
An inter-issuer payment is a payment between accounts issued by different issuers.
An intra-issuer payment is a payment between accounts issued by the same issuer.
In this document, a communication channel between two entities, is any means that provide the transport of digital messages between said two entities.
In graph theory and in this document, a Directed Acyclic Graph or DAG is a directed graph containing no directed cycles.
The length of a DAG is the length (number of edges) of the longest directed path in the DAG.
In this document, a retail payment is a payment with an amount that is normally used in payments between two persons or in payments between a person and a merchant.

The largest international electronic retail payment systems are card payment systems such as Visa™ and MasterCard™. The corresponding settlement systems are the VisaNet™ system run by Visa™ and BankNet™ run by MasterCard™. These systems are multi-issuer; several organizations participate as issuers in the payment and settlement systems. These systems and other prior art settlement systems use delayed net settlements. Typically, VisaNet™ runs settlements between issuers once per day. The net of inbound and outbound payments are computed and the resulting debt is settled between the issuer organizations. The settlement lag, that is, the time between payment and settlement, results in credit risk between issuers, or between issuers and the clearing organization. Because credit is given to issuers, issuers must have a very high credit worthiness. Less financially trusted parties are not allowed to participate as issuers in the systems. Typically, Visa™ and MasterCard™ issuers are banks.

PayPal™ provides real-time payments in a symmetric payment system. This system has a single issuer and therefore requires no settlements between different issuer organizations.

Real-time Gross Settlement Systems (RTGS) are used by central banks to handle inter-bank fund transfers. These systems do not introduce any credit risk due to settlement lags since a payment is made in real-time using central bank accounts. There are no settlements made at a later time; once a payment has been made, it is final and irrevocable. Current RTGS systems are not suited for small retail payments and they have a single account issuer. A central bank is typically the single account issuer and the accounts are typically held by banks. RTGS systems handled by central banks handle a single currency. Often, only banks and a few clearing organizations are allowed to participate as users in RTGS systems.

TARGET is a real-time settlement system that connects several RTGS systems run by central banks of EU member states to provide trans-European transfers between banks. TARGET handles only the EUR currency. All payments are made in funds deposited at European central banks. There are no settlement lags and therefore no credit risk associated with settlement lags.

It is common for banks to use the SWIFT (Society for the Worldwide Interbank Financial Telecommunication) system to execute international payments. Currently, international payments go through a settlement process that typically takes two days for payments that involve more than one currency. The authors of U.S. patent application 2003/0208440 describe a system that they say can be used to bypass the traditional international settlement system by introducing a treasury account. Thereby the payment execution speed would increase. The system described in the mentioned patent application increases payment execution speed, but does not fulfill the other objects of the present invention and has a completely different technical solution.

Consider an international retail payment from a customer (payer) to a merchant (receiver) using a Visa™ debit card. Further assume the customer is from Germany and that his Visa™ card is connected to a bank account in EUR. The merchant has a bank account in USD and the price for the product to be bought is given in USD. Current multi-currency retail payment systems, such as Visa™, do not typically provide the customer with the exact amount that will be withdrawn from his account, before the payment must be confirmed. Instead the price is only given in the merchant currency (USD for this example). The actual amount payed by the customer is determined later by Visa™ at issuer settlement time and could be on the date of the purchase or several days later.

Embodiments of the present invention improve the situation for customers, since the exact payment amount in both the payer currency and the receiver currency is known before the payer confirms the payment.

Embodiments of the present invention solve these problems with a different solution: true real-time, multi-currency payments. There are no settlements at a later time; multi-currency payments are processed in real-time; a few seconds after the payer confirms the payment, the payment will be irrevocably executed. The confirmed payer amount is withdrawn from the payer account and the confirmed receiver amount is deposited to the receiver account.

Thus, prior art retail payment systems are either single-issuer, or have settlement lags that cause credit risk between issuers and the need for a separate settlement system. Current systems do not provide real-time payments, but half-delayed payments. With the increase of Internet trade, the need for multi-currency real-time payments is growing. Furthermore, there is a need for an efficient payment system that not only works for person-to-business payments, but also for person-to-person payments and business-to-person payments.

Embodiments of the present invention provide international, multi-currency, real-time payments between accounts issued by different organizations.

Embodiments of the invention eliminate credit risk between account issuers due to settlement lags.

Embodiments of the present invention realize multi-currency payments as a sequence of simple balance transfers in, possibly existing, monetary account systems.

Embodiments of the invention provide users of the payment system with information on the exact amount that will be withdrawn from the payer account expressed in the currency of the payer account and the exact amount that will be deposited on the receiver account expressed in the currency of the receiver account, before a payment is confirmed.

Embodiments of the present invention is to provide a payment system that provides high scalability and high availability through redundancy.

Using one or more of the embodiments of the present invention, existing or new, or both existing and new monetary account systems can be interconnected with each other in a hierarchical structure to create a real-time, multi-issuer, multi-currency, symmetric payment system that is suitable for retail payments. The hierarchical structure of issuers, and the novel method of realizing a payment as a sequence of simple balance transfers in participating account systems, are the building blocks of the invented payment system. Multiple currencies are supported by the very nature of the system, there is no need for special currency exchange methods.

An important feature of the embodiments of the invented payment system is that settlements between issuers are made in real-time in the same system as the payments. There is no time lag between a payment and the corresponding settlement, as is the case of prior art retail payment systems. The credit risk due to settlement lag is completely eliminated. This allows organizations with less credit worthiness to participate as issuers in the payment system without possible harm to other issuers. Of course, account issuers in any payment systems should be credit worthy, but the described payment system makes it feasible to have non-bank organizations as issuers. For example, mobile phone operators, Internet community sites, and existing e-wallet systems are possible issuers.

Embodiments of the invented payment system can consist of a number of connected account systems.

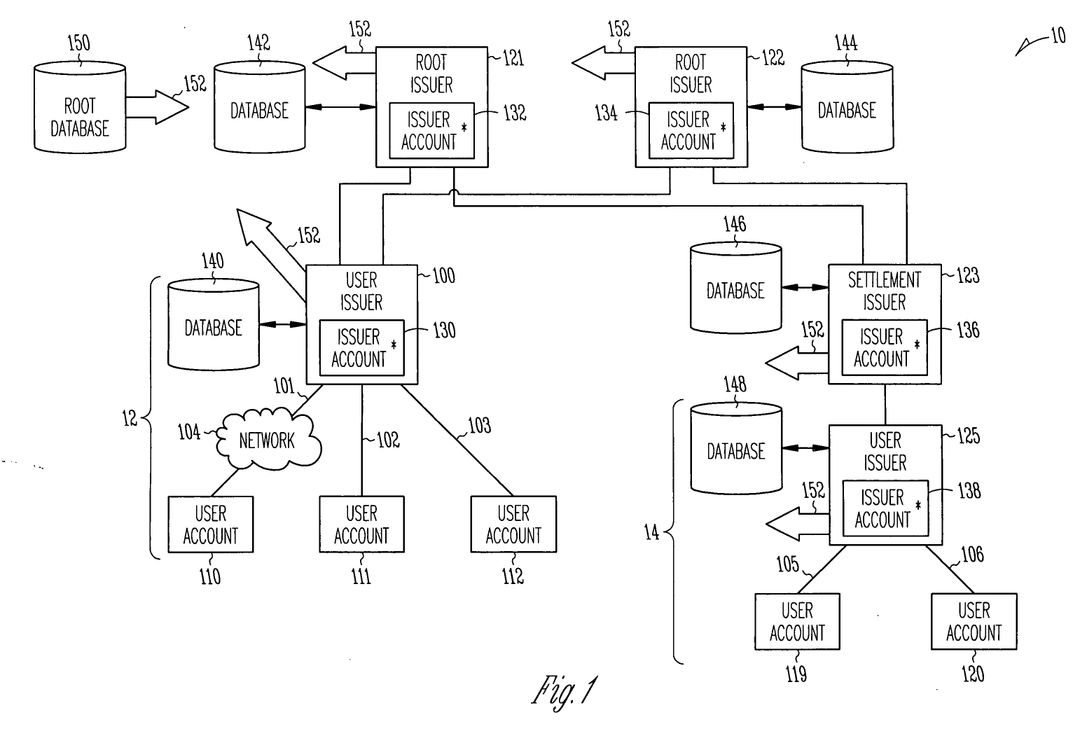

FIG. 1 shows a payment system 10 including a plurality of account systems. In various embodiments, payment system 10 includes issuers 100, 119, 120, 121, 122, and 123. Issuer 100 and issuer 125 are referred to as a user issuers because each of issuer 100 and 125 provide one or more user accounts. By way of illustration, user issuer 100 provides, and is coupled to, three user accounts 110, 111, 112 by connections between them 101, 102, and 103 respectively. By way of illustration, user issuer 125 provides, and is coupled to, two user accounts 119 and 120. In various embodiments, the connections between user issuers and user accounts are encrypted communication channels in a computer network. In one embodiment of the invention, the communication channels are SSL/TCP sockets over the public Internet. In various embodiments, one or more of the communication channels includes a network 104 as part of the communication channel.

As shown in FIG. 1, each user issuer is coupled to one or more settlement issuers. Settlement issuers are issuers such as issuers 121, 122, and 123 that do not directly provide user accounts, but are communicatively coupled to user issuers in payment system 10. As shown in FIG. 1, settlement issuer 123 is communicatively coupled to user issuer 125, and to root issuer 122. In various embodiments, an issuer is referred to as a root issuer if the issuer is a parent or highest level issuers in a payment system and coupled only to one or more child issuers, such as settlement issuer 123, or user issuers 100 and 125. As shown in FIG. 1, user issuer 100 is communicatively coupled to each of root issuer 121 and 122.

In various embodiments, an issuer includes an issuer account. As shown in FIG. 1, user issuer 100 includes user account 130, root issuer 121 includes issuer account 132, root issuer 122 includes issuer account 134, settlement issuer 123 includes issuer account 136, and user issuer 125 includes issuer accounts 138. In various embodiments, issuer accounts are operable to maintain information regarding the user accounts provided by a user issuer.

In various embodiments, an issuer is coupled to a database. As shown in FIG. 1, user issuer 100 is coupled to database 140, root issuer 121 is coupled to database 142, root issuer 122 is coupled to database 144, settlement issuer 123 is coupled to database 146, and user issuer 125 is coupled to database 148. Databases 140, 142, 144, 146, and 148 are operable to store data related to the issuer to which the database is coupled, including storing information included in the issuer account incline in the issuer to which the database is coupled.

In various embodiments, payment system 10 includes a root database 150. Root database is operable to store any information related to payment system 10, including any information and data needed to operate the payment system 10 according to any of the various embodiments described herein. In various embodiments, each of the issuer included in payment system 10 have access to, information and data in root database 150, as represented by arrow 152 in FIG. 1. In various embodiments, each of the issuer included in payments system 10 and store information, including information and data within the issuers respective issuer account, in root database 150.

In various embodiments, an account system includes a user issuer and the user accounts provided by the user issuer. By way of illustration, user issuer 100 and user accounts 110, 111, and 112 can form an account system 12. In another illustration, user issuer 125 and user accounts 119 and 120 can form another accounts system 14. In various embodiments, some combination of root issuer 121, 122, and settlement issuer 123 are operable to communicatively coupled accounts system 12 and 14 in order to perform payment transfers according to the various embodiments described herein.

In various embodiments, each account system provides accounts in only a given currency. By way of illustration, user issuer 100 in FIG. 1 issues accounts to its customers in the currency Euro (EUR). In this description, a single account system is assumed to handle a single currency. This is not a limitation of the system as a whole, but a convenient definition of an account system participating in the payment system. An organization offering accounts to its customers in many currencies, can technically function as several issuers (one for each currency). The specification does not describe how users connect to their issuer, how users are authenticated to the issuer, how issuers are authenticated to their users and similar issues. The details of the participating account systems can vary without influencing the interoperability. Participating account systems should be real-time, symmetric payment systems. Existing monetary account systems, such as bank accounts, e-wallet accounts, or mobile subscriber accounts, can be used as account systems in the invented payment system. This approach is used to enable reuse of existing systems and customers to the widest extent possible. Other successful electronic retail payment systems, such as Visa™ and MasterCard™, also have the capability of reusing existing accounts.

A payment within a single account system (an intra-issuer payment) is realized with a decrease of the balance of the payer account and corresponding increase of the balance of the receiver account. Payments are final when this balance transfer is written to the books (the database) of the user issuer. User issuers that have end users as account holders are called user issuers. This term is used to distinguish these issuers from settlement issuers that have other issuers as account holders.

Each account system has a special account called the issuer account. This account is owned by the issuer and is used for inter-issuer payments. The account is often denoted with an asterix (*).

Issuers are interconnected as a directed acyclic graph (DAG) called the issuer graph. The root issuers are on the top of the graph. Every issuer except the root issuers is connected to one or more parents (or parent issuers) above them in the issuer graph. Parent issuers are connected to their children below them in the issuer graph. Settlement issuers have other settlement issuers or user issuers as children. End users may or may not be included in the DAG when shown in figures. Using graph theory terminology, the root issuers are the sources of the DAG. The user issuers are the sinks of the DAG if end users are omitted from the graph. If end users are included in the DAG, the end users are the sinks. The direction of the edges of the DAG is always downwards and therefore not shown in figures. For the payment system to be complete, so every user can pay to any other user, all user issuers must have a direct or indirect parent in common.

Each connection (edge) in the issuer graph represents a monetary relationship between an issuer and one of its account holders (below in the graph). The connections also represent encrypted communication channels used to send digital messages. Each issuer runs an account system. Besides handling accounts of its own account system, all issuers except root issuers, have one account in the account system of each parent issuer. The invention is to connect these account systems in a DAG and to follow a method (DAGPAY) that realizes a payment between two end users as a sequence of simple balance transfers in participating account systems.

Issuers have accounts at parent issuers to cover payments made from the children of the issuer to other issuers. A user issuer does not need to have the sum of all its user accounts on its parent accounts. At all time, there should be enough money on the parent accounts to cover payments to other issuers. The balance on a parent account is adjusted by deposits and withdrawals using traditional bank systems. These deposits and withdrawals can be made on a daily basis, weekly basis, or whenever needed. Issuer settlements are made in real-time, and the payment system runs 24 hours a day. There are no special settlement times. If there is not enough funds on a parent account to complete a payment to another issuer, the payment will not be processed at all.

The design of the invented payment system with a hierarchical structure of issuers makes the system scale to handle all payments needed by private persons worldwide. Payments are often local. For example, payments between account holders in the same country are more common than international payments. Local payments are handled locally in the hierarchy of issuers. Instead of using a single processing facility, payment processing is distributed. For example, a payment between accounts of the same issuer, intra-issuer payments, do not involve other parties than the issuer itself.

To understand the issuer graph and how payments are made, examples are given before a more general description is made.

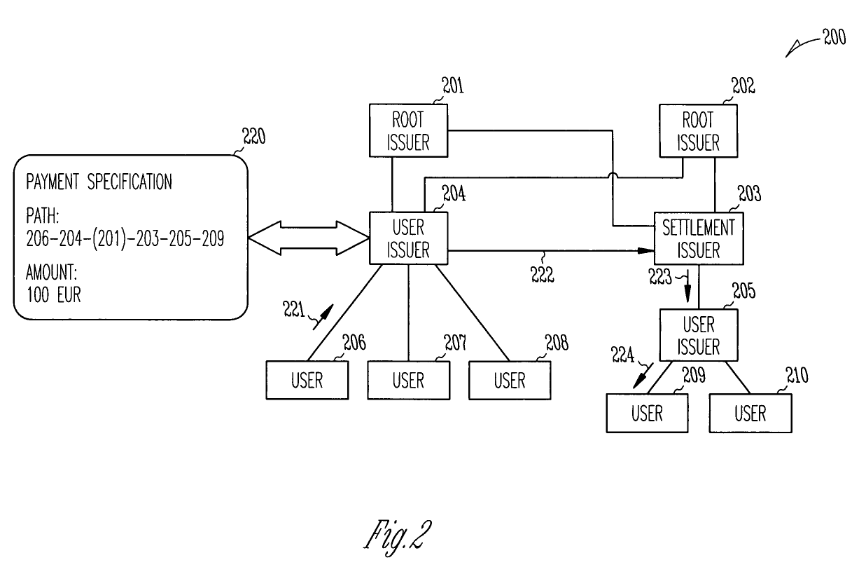

FIG. 2 shows an example of an issuer graph 200 with five users (206, 207, 208, 209, and 210), two user issuers (204, 205), and three settlement issuers (201, 202, 203). Issuers 201 and 202 are the root issuers. The system is complete since every pair of user issuers have a common direct or indirect parent. FIG. 2 shows how a payment of 100 EUR from User 206 to User 209 is realized using four balance transfers in four account systems. The first transfer (221 in FIG. 2) is made in account system 204 from user account 206 to the issuer account of Issuer 204, denoted 204*. By introducing a compact notation for balance transfers, the transfer can be expressed as:

206—>204* or 206—100 EUR—>204* if the amount is of importance.

The following four transfers realize the payment:
221. 206—>204*
222. 204—>203
223. 203*—>205
224. 205*—>209.

All transfers use the amount 100 EUR. Seen from the user perspective, these transfers realize the payment by moving a claim by User 206 on Issuer 204 to a claim by User 209 on Issuer 205. Claims between issuers are settled immediately using these transfers. The issuer of the payer (204) pays to the issuer of the receiver (205) using the same system. The payment between issuer 204 and 205 is realized using two balance transfers (222. and 223. in FIG. 2). Transfers going up the graph are called up transfers. Transfers going down the graph are called down transfers, and the transfer in the top-most account system is the top transfer. Up transfers are transfers from ordinary accounts to issuer accounts. Down transfers are transfers from issuer accounts to ordinary accounts. The top transfer is a transfer between two ordinary accounts. Remember that a transfer is made between two accounts in the same account system.

A distributed payment system must handle failures of involved systems gracefully. Using common database terminology, a payment must have ACID (Atomicity, Consistency, Isolation, Durability) properties. This is realized by using the ACID properties of the top account system involved in a payment. Payments are final and irrevocable when the top transfer has committed in the database of the top issuer. It is the responsibility of the top issuer to make sure the payment transactions are stored durably. Durability of database transactions can be solved using available technology. The top issuer stores all information about the payment, not only the information needed for the top transfer, but information about all transfers that are used to realize the payment. The payment transaction is final and irrevocable immediately as the top transfer commits in the database of the top account system.

The debited accounts of all up transfers and the top transfer are called the paying accounts of a payment. Likewise, the credited accounts of all down transfers and of the top transfer are called the receiving accounts of a payment. A payment is only processed if the balance of each paying account is greater than or equal to the payment amount. This procedure of checking the balance of all paying accounts before the payment is processed is what eliminates credit risk due to settlement lags. Not only is the balance of the end user checked in real-time, but also the balance of its issuer.

The example payment could be realized using another payment path. Instead of the path 206-204-(201)-203-205-209 as shown in FIG. 2, the path 206-204-(202)-203-205-209 could have been used instead. The latter path uses Issuer 202 as the top issuer instead of Issuer 201. The payment path is determined before the first balance transfer is made for a specific payment. Exactly how the payment path is determined in the system is out of the scope of this invention. High system uptime and no single point of failure can be attained by building a DAG allowing multiple payment paths. Another way to attain high uptime is to use redundant database systems for every participating issuer.

In various embodiments, there is a database available to all issuers in the system. In various embodiments, it is called the root database, and contains current information about the topology of the DAG, the status of individual issuers, the balances of all accounts issued by settlement issuers, and current currency exchange rates. Exactly how this database is realized is not further discussed. Existing database technology can be used to create the root database. In various embodiments, the root database is a database distributed on many servers. Also, different issuers may only have access to a subset of the whole database information. For example, in one implementation, there is no global database that contains the whole graph topology information. This information is instead distributed in the network but still allows payments to be routed properly from payer to receiver.

In various embodiments, when a user requests that a payment is to be made from his account, a payment specification, such as payment specification 220 as shown in FIG. 2, is created by the issuer of the user. If the payment is not an inter-issuer payment, but an intra-issuer payment, the payment is processed within the account system independent of the rest of the system.

In various embodiments, a payment specification includes the following information: payment path, amounts, and typically also a payment message and identification numbers for the payment. In various embodiments, further auxiliary data is included in the payment request. For this discussion, only the payment path and the amounts are important. FIG. 2 shows the payment specification 220 for the example payment shown in the figure. The payment specification 220 is created by the issuer of the payer and is based on available information in the root database, and information from the payer. The payment path can be chosen, for example, to avoid an issuer that is down or an issuer that is scheduled to go down for maintenance in a few seconds. The path is specified in such a way that payment processing can be made locally if possible. The shortest path, involving as few issuers as possible, is chosen. The amounts are determined by the payer request and the current currency exchange rates in the root database. The example payment in FIG. 2 uses EUR as the single currency of all participating issuers.

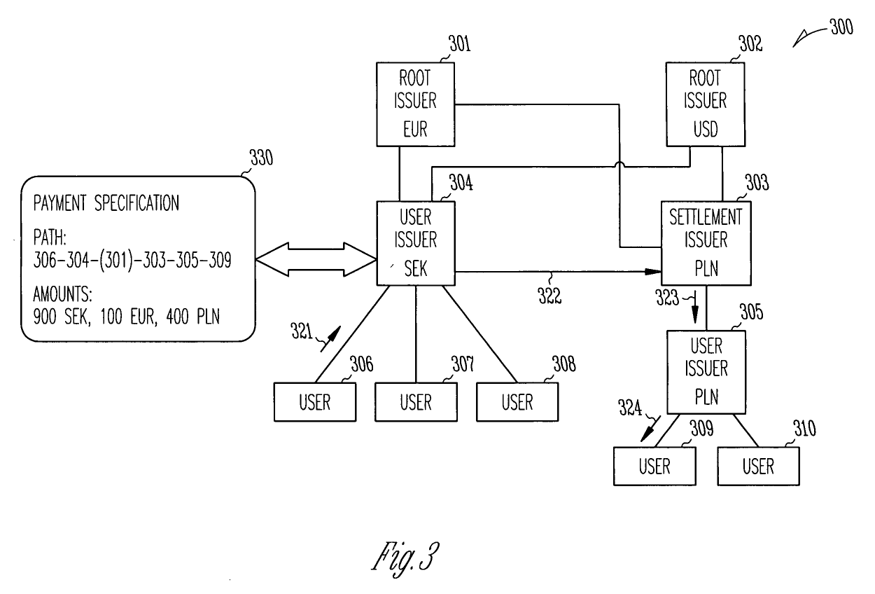

FIG. 3 shows an example of a hierarchy of issuers and a multi-currency inter-issuer payment in a payment system 300. Consider the example of a payment from 306 to 309 (can be denoted 306==900 SEK, 100 EUR, 400 PLN=>309). The payment specification is created by 304 and includes the payment path and the payment amount expressed in all currencies passed on the payment path between payer and receiver. The amounts are computed based on current exchange rates from the root database (not shown in FIG. 3). Note that the amount in both the payer's currency and the receiver's currency is specified before the payment is processed. This means the payer will be able to see the exact amount that will be withdrawn from his account to pay a certain amount to the receiver before the payment is confirmed by the payer. This is an advantage compared to current multi-currency retail payment systems where the payment amount is specified using only the currency of the receiver, or only the currency of the payer. The payment in FIG. 3 is realized with the following four balance transfers:
321. 306—900 SEK—>304*
322. 304—100 EUR—>303
323. 303*—400 PLN—>305
324. 305*—400 PLN—>309.

This section describes how issuers handle payments for the general case. In various embodiments, the method is called DAGPAY. Intra-issuer payments are not considered. Such payments are made in a single account system independent of the rest of the system.

The issuer of the payer (IP) creates the payment request (PR) on request of the payer or on request of someone with permission to do so. The PR is valid if the payment path is possible in the issuer graph and the balances of all paying accounts are equal to or greater than the payment amount. The payment amounts are computed from the request of the payer and the current exchange rates in the root database. If the PR is valid it is sent to the next issuer in the payment path.

An issuer (I) that receives a PR from one of its children (C1) handles the request the following way. If the next part of the payment path is a child of I (C2), a top transfer is performed in the database of I (C1—>C2) and the payment is irrevocable. A notification is sent to C1, and PR is sent to C2. If the next part of the payment path is instead a parent of I (P) an up transfer is performed in the system of I (C1—>I*) and PR is sent to P.

An issuer (I) that receives a PR from one of its parents handles it by executing a down transfer (I*—>N) to the next element (N) of the payment path. N is either another issuer, or an end user. If N is an end user, the payment is completed, since all transfers have been made.

The amounts of the balance transfers are given from the amounts specified in the original PR. All issuers on the payment path should confirm that the amounts are correct given the current exchange rates.

The DAG hierarchy of issuers, the DAGPAY method of handling payments, and the fact that the balances of all paying account are checked in real-time, are described herein as being included in various embodiments of the present invention. The payment system is designed for reuse of existing monetary account systems and has several advantages over prior payment systems. A novel advantage of the invented payment system is that user issuers never have unsettled claims on other user issuers. Inter-issuer payments and settlements between issuers are handled in real-time by settlement issuers. Multiple currencies are supported by the very nature of the system. A payment is realized as a sequence of simple balance transfers in ordinary account systems. The amount to pay is determined in all currencies before the payment is processed. This allows the payer and the receiver to agree on a payment amount, expressed in both the currency of the payer and the currency of the receiver, before the payment is executed. Embodiments of the payment system provides real-time, multi-currency payments for multiple issuers. Due to the hierarchical design, the payment system scales to handle all electronic payments needed by private persons worldwide.

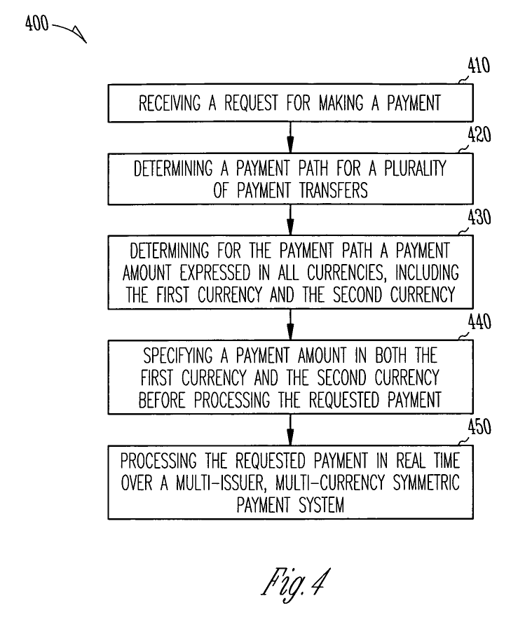

FIG. 4 shows a flowchart 400 for various methods for performing a payment.

At block 410, the various methods include receiving a request for making a payment, the payment including an amount specified in a first currency.

At block 420, the various methods include determining a payment path for a plurality of payment transfers. In various embodiments, the payment path includes at least one issuer along the payment path that provides user accounts in a second currency that is different from the first currency.

At block 430, the various methods include determining for the payment path a payment amount expressed in all currencies, including the first currency and the second currency.

At block 440, the various methods include specifying the a payment amount in both the first currency and the second currency before processing the requested payment.

At block 450, the various methods include processing the requested payment in real time over a multi-issuer, multi-currency symmetric payment system.

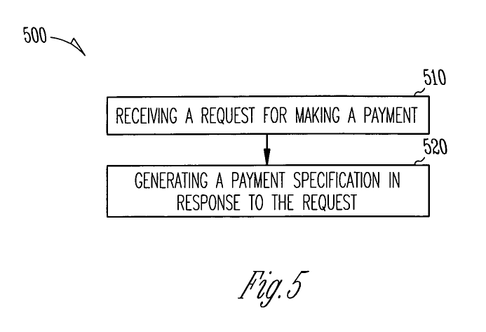

FIG. 5 shows a flowchart 500 for various method for generating a payment specification.

At block 510, the various methods include receiving a request for making a payment.

At block 520, the various methods include generating a payment specification in response to the request. In various embodiments, generating the payment specification includes generating the payment specification including information including a payment path through a directed acyclic graph so that the request for the payment can be executed in real time in a multi-issuer, multi-currency, and symmetric payment system.

Various embodiments of payment systems and methods have been described herein.

Various embodiments include a computer network for making electronic payments between accounts issued by different issuers, comprising a plurality of user issuers, each of the user issuers operable to provide one or more user accounts, each of the user issuers including a separate payment account; a plurality of issued user accounts, each one of the plurality of issued user accounts issued by one of the user issuers, and each one of the plurality of issued user accounts communicatively coupled though a communication channel to the user issuer that issued the given issued user account; and at least one settlement issuer, the settlement issuer communicatively coupled to one or more of the plurality of user issuers, the at least one settlement issuer including settlement payment account, the settlement issuer having access to a balance in each of the separate payment accounts, wherein each of the user issuers are operable to receive a request to make a payment for an amount from one of the one or more user accounts provided by the user issuer to one of the issued user account issued by a different user issuer, the user issuer receiving the request operable to create a payment specification in response to the request, the payment specification including a payment path through the at least one settlement issuer from the user issuer receiving the request to the different user issuer, wherein the payment specification is determined to be valid if the payment path is possible through the computer network, and if the balances in each of the separate payment accounts and any settlements payment accounts included in one or more up transfers included in the payment path are equal to or greater than the payment amount.

Various embodiments include a method for performing a payment, comprising receiving a request for making a payment, the payment including an amount specified in a first currency, determining a payment path for a plurality of payment transfers that includes at least one issuer along the payment path that provides user accounts in a second currency that is different from the first currency, determining for the payment path a payment amount expressed in all currencies, including the first currency and the second currency, specifying the a payment amount in both the first currency and the second currency before processing the requested payment; and processing the requested payment in real time over a multi-issuer, multi-currency symmetric payment system.

Various embodiments include a method for performing a payment, comprising receiving a request for making a payment, and generating a payment specification in response to the request, the payment specification including information including a payment path through a directed acyclic graph so that the request for the payment can be executed in real time in a multi-issuer, multi-currency symmetric payment system.

What is claimed is:

1. A computer network for making electronic payments between monetary accounts issued by different issuers, comprising:
a plurality of user issuers, each of the user issuers operable to provide one or more user accounts, each of the user issuers including a separate payment account;
a plurality of issued user accounts, each one of the plurality of issued user accounts issued by one of the user issuers, and each one of the plurality of issued user accounts communicatively coupled though a communication channel to the user issuer that issued the given issued user account; and
at least one settlement issuer, the settlement issuer communicatively coupled to one or more of the plurality of user issuers, the at least one settlement issuer including settlement payment account, the settlement issuer having access to a balance in each of the separate payment accounts,
wherein each of the user issuers are operable to receive a request to make a payment for an amount from one of the one or more user accounts provided by the user issuer to one of the issued user accounts issued by a different user issuer, the user issuer receiving the request operable to create a payment specification in response to the request, the payment specification including a payment path through the at least one settlement issuer from the user issuer receiving the request to the different user issuer,
wherein the payment specification is determined to be valid if the payment path is possible through the computer network, and if the balances in each of the separate payment accounts and any settlement payment accounts included in one or more up transfers included in the payment path are equal to or greater than the payment amount.

2. The computer network of claim 1, wherein each of the separate payment accounts is stored in a common root database.

3. The computer network of claim 1, wherein at least one of the communication channels includes a network.

4. The computer network of claim 1, wherein at least one of the user issuers is operable to provide the one or more user accounts in a single currency.

5. The computer network of claim 1, wherein at least one of the user issuers is operable to provide the one or more user accounts in a first currency, and a different one of the user issuers is operable to provide user accounts in a second currency that is different from the first currency.

6. The computer network of claim 5, wherein the first user issuer and the second user issuer are included in a same organization.

7. The computer network of claim 1, further including:
a root database, the root database accessible by the user issuers and by the settlement issuers, the root database operable to store a current value for each of one or more currency exchange rates.

8. The computer network of claim 1, wherein the amount is determined by a payer specified payment amount, and by one of the currency exchange rates included in the root database.

9. The computer network of claim 1, wherein the payment path includes at least one user issuer providing user accounts in a first currency, and at least one user issuer providing a user accounts in a second currency that is different from the first currency.

10. The computer network of claim 1, wherein the payment path that a fewest number of user issuers and settlement issuers within the computer network as possible is chosen.

11. The computer network of claim 1, wherein the payment path includes a top transfer including a payment transfer at the top issuer, and wherein the payment request becomes irrevocable substantially at the time the top transfer commits in a database of the top issuer.

12. A method for performing a payment comprising:
receiving a request for making a payment, the payment including an amount specified in a first currency;
determining a payment path for a plurality of payment transfers that includes at least one issuer along the payment path that provides user accounts in a second currency that is different from the first currency;
determining for the payment path a payment amount expressed in all currencies, including the first currency and the second currency;
specifying the a payment amount in both the first currency and the second currency before processing the requested payment; and
processing the requested payment in real time over a multi-issuer, multi-currency symmetric payment system.

13. The method of claim 12, wherein determining the payment amounts expressed in all currencies includes:
accessing one or more currency exchange rates stored in a root database; and
computing the payment amounts based the accessed currency exchange rates.

14. The method of claim 12, wherein the payment path includes a least number of issuers necessary in order to provide the payment path.

15. The method of claim 12, wherein processing a request in real time includes: making a real-time payment for which a monetary amount paid can be reused for new payments by a receiver within one minute after the real-time payment was initiated by the payer.

16. The method of claim 12, wherein processing the requested payment includes
providing a user of the payment system with information on a first exact amount that will be withdrawn from a payer account of the user, the exact amount expressed in the currency of the payer account, and
providing a second exact amount that will be deposited on the receiver account expressed in the currency of the receiver account,
all before a payment is confirmed.

17. A method for performing a payment comprising:
receiving a request for making a payment; and
generating a payment specification in response to the request, the payment specification including information including a payment path through a directed acyclic graph so that the request for the payment can be executed in real time in a multi-issuer, multi-currency symmetric payment system.

18. The method of claim 17, wherein the payment corresponding to the payment specification can be executed with substantially no time lag between the payment and a corresponding settlement.

19. The method of claim 17, wherein the payment specification includes a payment amount, the payment amount specified in a first currency provided in a first user account issued by a first user issuer in the directed acyclic graph that is different from a second currency provided in a second user account issued by a second user issuer in the directed acyclic graph.

20. The method of claim 19, including:
computing the payment amount based on an amount included in the request, and based on one or more current exchange rates.
